(19) United States
(12) Patent Application Publication
(10) Pub. No.: US 2021/0229864 A1
(43) Pub. Date: Jul. 29, 2021

(54) BOTTLE CARRIER HUNG FROM TOILET PAPER HOLDER

(71) Applicant: Bryant Bayer Lee, Northbrook, IL (US)

(72) Inventor: Bryant Bayer Lee, Northbrook, IL (US)

(21) Appl. No.: 16/934,892

(22) Filed: Jul. 21, 2020

Related U.S. Application Data
(60) Provisional application No. 62/966,904, filed on Jan. 28, 2020.

(51) Int. Cl. B65D 23/00; F16B 2/08

(52) U.S. Cl. CPC B65D 23/003; A47K 10/22; F16B 2/08

(57) ABSTRACT

A bottle carrier includes a ring configured to couple with a toilet paper holder. Further, the bottle carrier includes a stem configured to couple with the ring. Further still, a caddy is configured to couple with the stem opposite the side coupled with the ring. The bottle carrier is configured to carry a bottle of toilet paper wetting fluid.

### REFERENCE TO RELATED APPLICATIONS

This application claims priority to U.S. Provisional Application No. 62/966,904, filed on Jan. 28, 2020, entitled BOTTLE CARRIER HUNG FROM TOILET PAPER HOLDERS, to inventor Bryant Bayer Lee, the entirety of which is herein incorporated by reference.

### BACKGROUND

In many countries, dry toilet paper is customarily used to wipe after going to the bathroom. However, despite numerous reports which indicate incorporating some form of liquid after going to the bathroom is more hygienic, through use of bidet, wet wipes, toilet paper spray, soap, or even water, widespread use is limited.

For example, while bidets are common among certain socioeconomic communities in certain European and Asian countries, there has not been widespread adoption, due to the cost, complexity, and negative stigma associated with them. Separately, while many wet wipes have been marketed as “flushable,” doing so can cause a variety of public health concerns, including plumbing backups and septic tank damage.

Toilet paper spray, soap, gel and foam bottles exist to enable a cleaner and more hygienic wipe. In the last few years many different toilet paper sprays have entered the market. These toilet paper sprays are typically left on top of the toilet or on the floor, which undermines the purpose of optimizing hygienic practices. Additionally, if toilet paper sprays go unseen or are difficult to access, they are less likely to be used; out of sight, out of mind.

Accordingly, there is a need for a device that encourages toilet paper spray, gel or foam use by seamlessly positioning the bottle in convenient locations, while allowing easy operation. There is also a need for a carrier for toilet paper spray or foam bottles that are compatible with and leverages common bathroom designs, while at the same time, enables easy access to and operation of the bottle, without impeding access to toilet paper.

### SUMMARY

An exemplary embodiment is directed to a bottle carrier. The bottle carrier includes a ring configured to couple with a toilet paper holder. Further, the bottle carrier includes a stem configured to couple with the ring. Further still, the caddy is configured to couple with the stem opposite the side coupled with the ring.

In one exemplary embodiment the bottle carrier includes a ring configured to couple with a toilet paper holder. Further, the bottle carrier includes a stem configured to couple with the ring. Further still, the bottle carrier includes a clip configured to couple with the stem opposite the side coupled with the ring. The bottle carrier also includes a bottle configured to couple with the clip opposite the side coupled with the stem.

In another exemplary embodiment the apparatus includes a coupler for removably coupling with a portion of an object. Further, the apparatus includes a flexible member coupled to the coupler. Further still, the apparatus includes a dispenser holder configured to couple to the flexible member opposite the side coupled to the coupler.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The bottle carrier hung from toilet paper holders may, however, be embodied in many different forms and should not be construed as being limited to the embodiments set forth herein; rather, these embodiments are provided by way of illustration only and so that this disclosure will be thorough, complete and fully convey understanding to those skilled in the art.

### BRIEF DESCRIPTION OF THE DRAWINGS

FIG. 1 is an illustrative embodiment of a front angled view of the device.

FIG. 2 is an illustrative embodiment of a back view of the device.

FIG. 3 is an illustrative embodiment of a bottom perspective view of the device.

FIG. 4 is an illustrative embodiment of a top view of the device.

FIG. 5 is an illustrative embodiment of an alternative configuration of the device.

FIG. 6 is an illustrative embodiment of an alternative design of the device.

FIG. 7 is an illustrative embodiment of an alternative design of the device.

FIG. 8 is an illustrative embodiment of an alternative design of the device.

FIG. 9 is an illustrative embodiment of an alternative design of the device.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

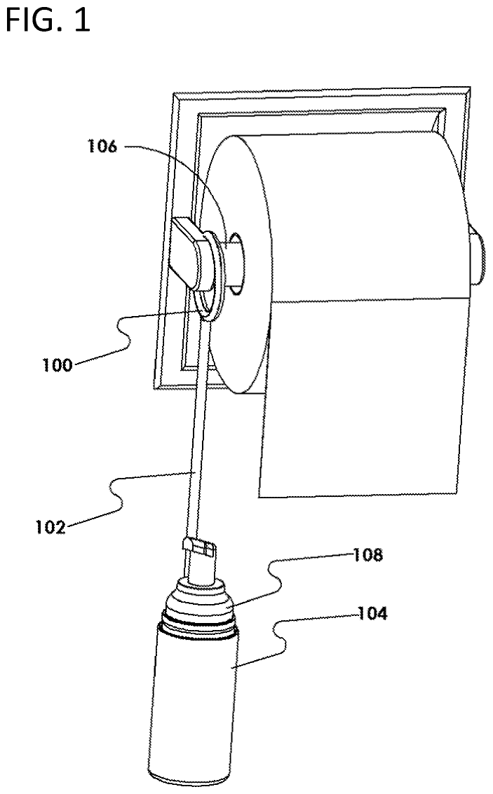

The subject matter presented is directed to hanging bottle carrier hung from toilet paper holders. Referring now to FIG. 1, is an illustrative embodiment of a front angled view of the device including a ring 100 that couples with an existing toilet paper holder member 106, a stem 102 that extends to a plurality of positions couples to a caddy 104 that secures a bottle 108.

In accordance with an illustrative embodiment the device may be made up of the following components: a ring 100 that attaches to an existing toilet paper holder apparatus 106 with varying dimensions that is also wide enough to place onto the bottle 108 for storage. Ring 100 may be any type of ring, partial ring, C-shaped ring, doubled over keyring, and any shape of ring including but not limited to circular. A flexible stem 102 may be connected to the ring 100 that has enough length to extend beyond the toilet paper and facilitate free movement of the bottle 108. The material may be loose or flexible enough so the stem 102 will not prevent normal operation of the bottle 108 where the bottle 108 may be tilted to apply foam to the toilet paper tissue. If the length of the stem 102 is not long enough, the bottle may interfere with the toilet paper and its operation and if the stem 102 is too long, it could be more difficult to operate and the bottle 108 is more likely to swing and bang against the surroundings. A caddy 104 may be connected to ring 100 and stem 102 that would hold and house bottle 108. Caddy 104 can be sized to hold a variety of shapes and sizes. Openings 120 in caddy 104 may be provided to allow airflow to aid the insertion of the bottle into caddy 104.

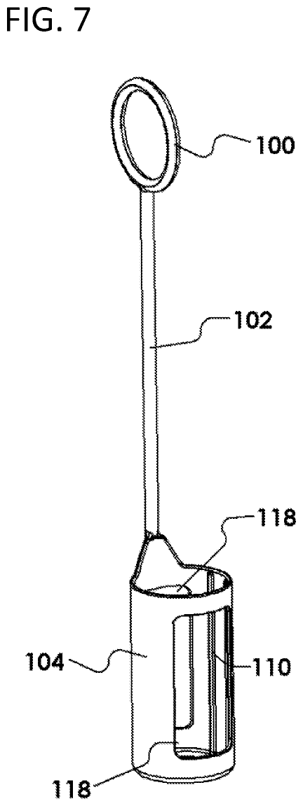

Other openings 118, as depicted in FIG. 7, may be formed in caddy 104 to enable visualization of the bottle and/or labels in order to see when refill of bottle 108 is needed or to read the bottle 108 label without removing it from caddy 104. Caddy 104 may be formed of a variety of materials. In some illustrative embodiments, material composition of caddy 104 may be provided to prevent damage to the surrounding wall and to ensure cleanability for example, plastic, silicone, rubber, wood, softer or metal, and others. Ribbed extensions 110 along the inside of the caddy 104 act to minimize contact between the material and bottle 108 thus enabling the ability to easily remove and replace the bottle 108 in the caddy 104.

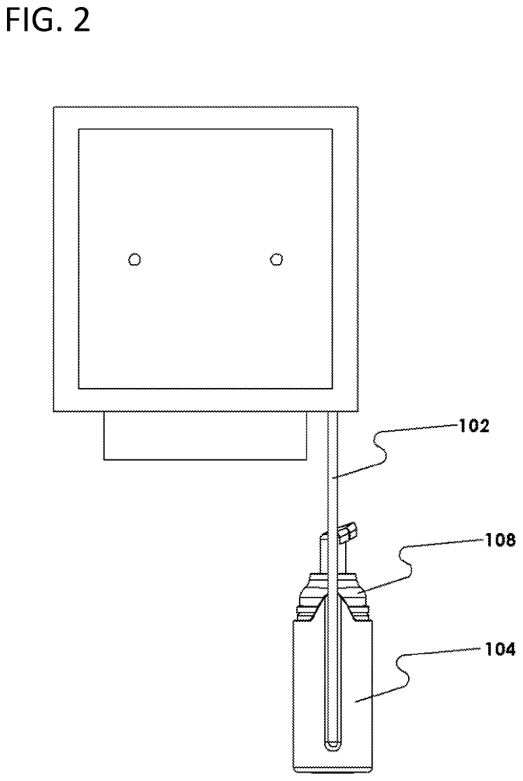

Referring now to FIG. 2, an illustrative embodiment depicting a back view of the device including stem 102 that couples with caddy 104 and secures bottle 108.

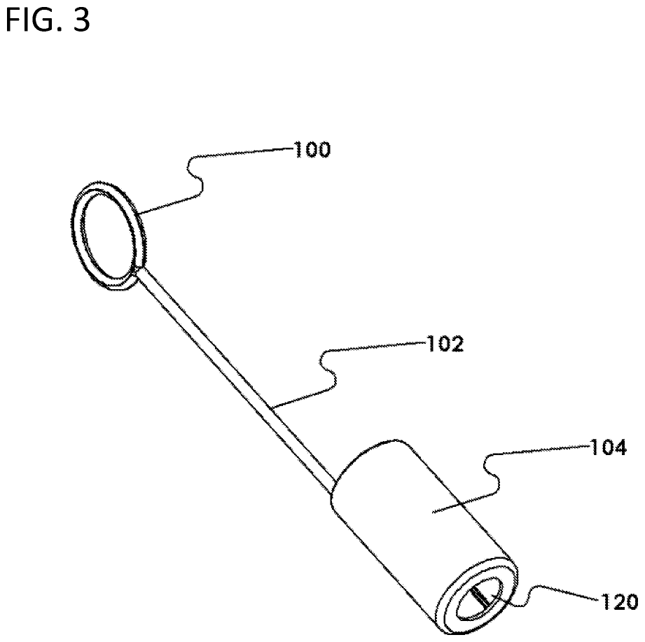

Referring now to FIG. 3, an illustrative embodiment of the device is shown in a bottom perspective view. The device includes an aperture 120 in the bottom of the caddy 104 to allow air passage through insertion of the bottle to prevent resistance in securing the bottle to the carrier.

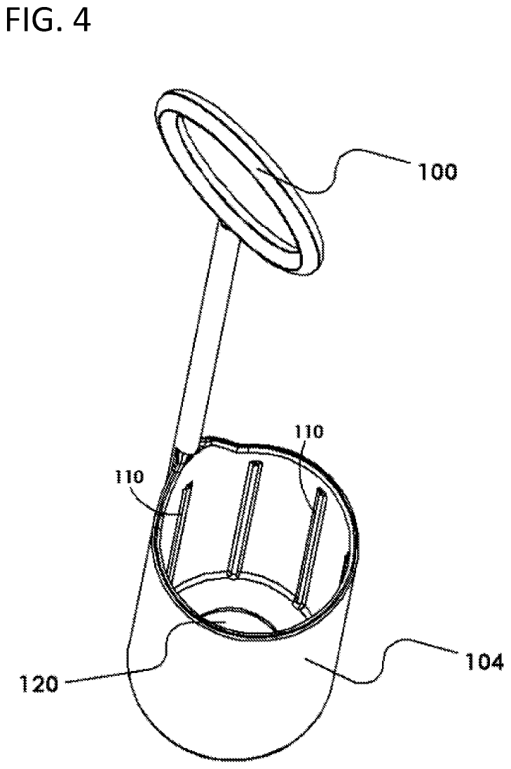

Referring now to FIG. 4, an illustrative embodiment of the device illustrating a top view of the device shows the presence of ribs 110 formed within the interior wall of the caddy to optimize contact between the bottle and caddy 104. Ribs 110 act to enable easier insertion, removal and rotation while still providing enough frictional contact to hold the bottle in the caddy.

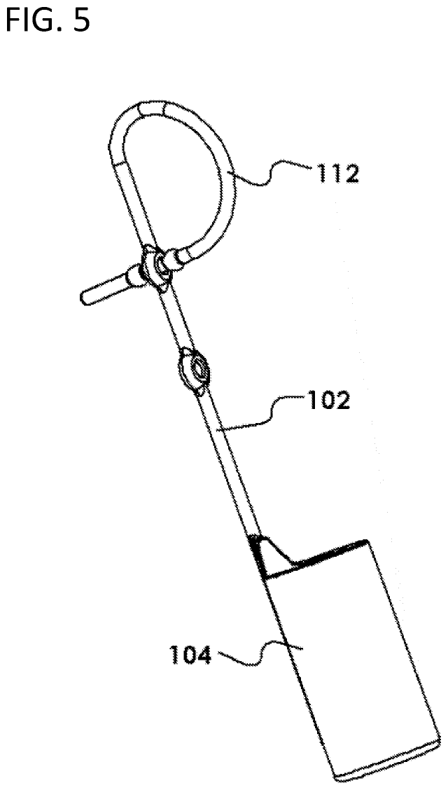

Referring now to FIG. 5, an illustrative embodiment of an alternative configuration having an adjustable ring 112 to couple the device to a toilet paper holder. The adjustable ring 112 enables customization of the coupler size to accommodate objects of different sizes. This configuration inherently also enables the length of stem 102 to be adjusted to accommodate different size bottles and proximities to a toilet user.

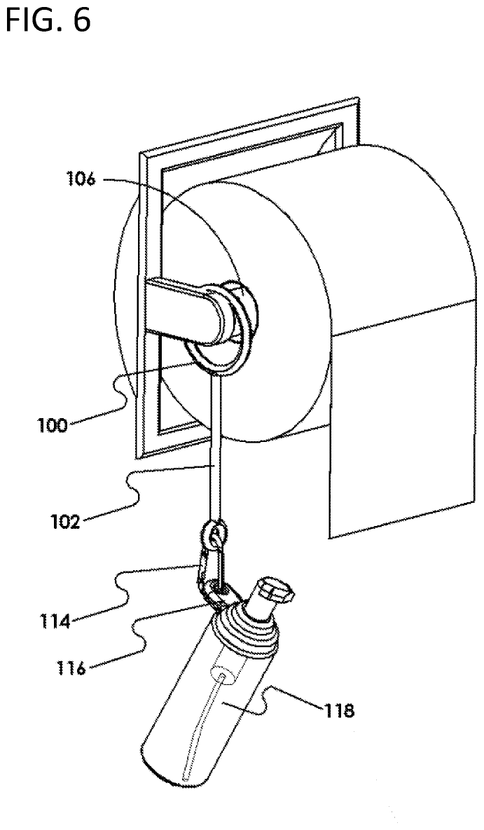

Referring now to FIG. 6, an illustrative embodiment of an alternative design where a direct connection is made with a modified bottle 125 without use of a caddy. This illustrative embodiment incorporates a clip 114, such as but not limited to a carabiner clip, which attaches to both the stem and a connection site 116 on the modified bottle 125, such that the bottle is securely fastened to the device. Any variety of clip and bottle combination may be used as long as they are complementary allowing the bottle to be coupled to stem 102.

Referring now to FIG. 7, an illustrative embodiment of an alternative design includes apertures 118 formed in the side of caddy 104 to enable visualization of the bottle or labels, allowing one to discern the contents or label of the bottle without removing it from the caddy 104. Apertures 118 are depicted as roughly rectangular in shape however apertures 118 may be formed of any shape without departing from the disclosed subject matter.

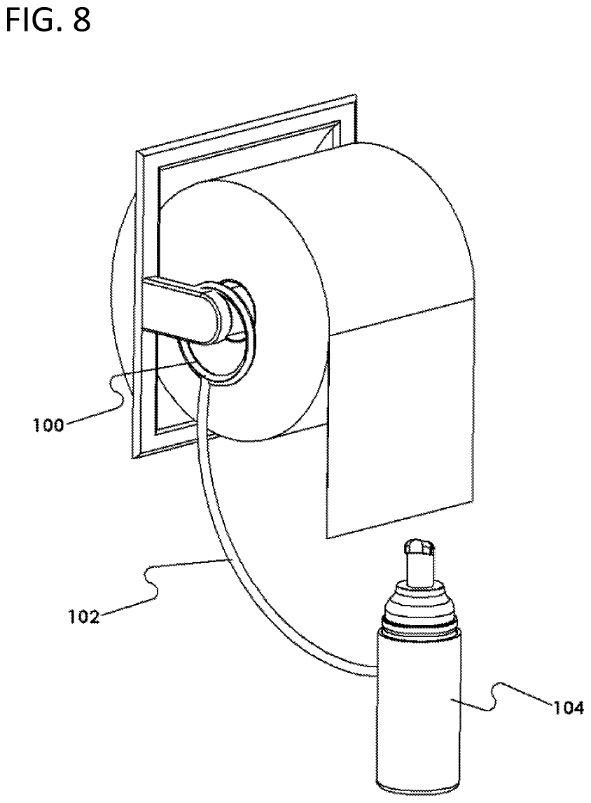

Referring now to FIG. 8, an illustrative embodiment of an alternative design of the device, is depicted. In an illustrative embodiment, stem 102 is flexible to a plurality of positions. Stem 102 may be comprised of memory material bendable to a plurality of positions and capable of maintaining positioning in any of the plurality of positions, enabling the caddy 104 to exhibit proximate a toilet user. Alternatively, stem 102 is merely a flexible material, such as but not limited to silicone, that can be easily pulled over near the user for use.

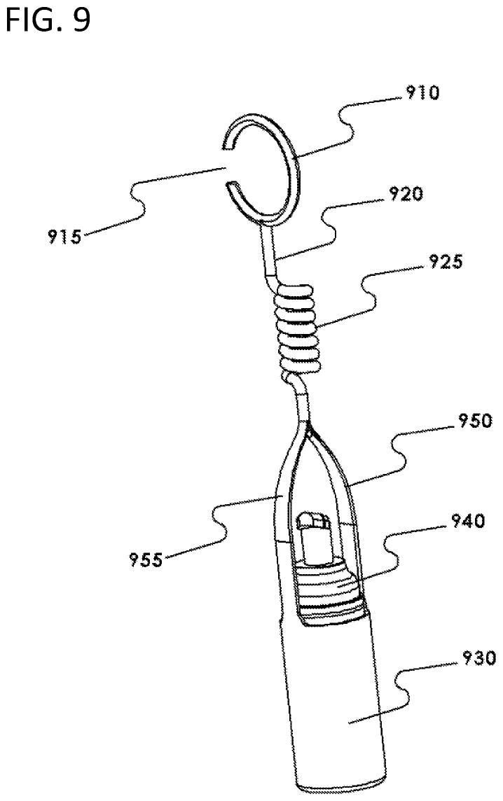

Referring now to FIG. 9, an illustrative embodiment of a front angled view of the device including a ring 910 that couples with an existing toilet paper holder with a stem 920 that extends to a plurality of positions couples to a caddy 930 that secures a bottle 940. Ring 910 is depicted with an opening 915 to form a C-Ring configuration. Ring 910 may be either flexble or rigid depending on the size of the opening as well as the material choice.

A flexible stem 920 may be connected to the ring 100 that has enough length to extend beyond the toilet paper and facilitate free movement of the bottle 940. Stem 920 may include a stretchable portion which may be a flexible coiled portion 925. Coiled portion 925 increases the reach of stem 920 when in use and retracts to a compact state when released to a rest position before or after use. Stem 920 may also be coupled to one or more supports 950 and 955 which support caddy 930. Supports 950 and 955 are illustrative and may be any of a variety of shapes sizes and number.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

1. A bottle carrier, comprising:
a ring configured to couple with a toilet paper holder member;
a single elongate flexible stem having a first end and a second end, the first end of the stem coupled to the ring; and
a caddy that secures a bottle by elastically coupling with the bottle, the caddy coupled to the second end of the stem, the caddy being substantially cylindrical with an open top proximate the second end of the flexible stem and a partially closed bottom opposite the open top, the partially closed bottom having an aperture formed therein, and the caddy includes one or more stand offs from the interior sides of the cylinder, the standoffs include at least one rib.

2. The bottle carrier of claim 1, wherein the ring circumference is adjustable to a plurality of lengths.

3. The bottle carrier of claim 1, wherein the stem is flexible to a plurality of positions and the bottle may be used in any of the plurality of positions while remaining in the caddy.

4. The bottle carrier of claim 1, wherein the stem is comprised of a material bendable to a plurality of positions and capable of maintaining positioning in any of the plurality of positions.

5. A bottle carrier, comprising:
a ring configured to couple with a toilet paper holder member;
a stem having a first end and a second end, the first end of the stem coupled to the ring;
a clip having a first end and a second end, the first end of the clip coupled to the second end of the stem; and
a bottle configured such that the second end of the clip securely fastens the bottle to the apparatus.

6. The bottle carrier of claim 5, wherein the ring circumference is adjustable to a plurality of lengths.

7. The bottle carrier of claim 5, wherein the stem is flexible to a plurality of positions.

8. The bottle carrier of claim 5, wherein the stem is comprised of a material bendable to a plurality of positions and capable of maintaining positioning in any of the plurality of positions.

9. The bottle carrier of claim 5, wherein the clip includes a carabiner.

10. An apparatus, comprising:
a coupler for removably coupling with a portion of an object;
a single elongate flexible member having a first end and a second end, the first end of the flexible member coupled to the coupler; and
a dispenser holder configured to secure a dispensing container by elastically coupling with the dispensing container, the dispenser holder coupled to the second end of the flexible member, the dispenser holder being substantially cylindrical with an open top proximate the second end of the flexible member and a partially closed bottom opposite the open top, the partially closed bottom having an aperture formed therein, and the dispenser holder includes one or more stand offs from the interior sides of the cylinder, the standoffs include at least one rib.

11. The apparatus of claim 10, wherein the coupler includes a ring.

12. The apparatus of claim 10, wherein the coupler includes a clip, the clip including a carabiner.

13. The apparatus of claim 10, wherein the coupler is adjustable to couple with various size portions of a toilet paper holder.

14. The apparatus of claim 10, wherein the flexible member is comprised of memory material bendable to a plurality of positions and capable of maintaining positioning in any of the plurality of positions.

15. The apparatus of claim 10, wherein the flexible member includes a length of silicone cording.

16. The apparatus of claim 10, wherein the flexible member includes a length of rubberized cording.

17. The apparatus of claim 10, wherein the dispenser holder is substantially formed of silicone.

18. The apparatus of claim 10, wherein the single elongate flexible member includes a coiled portion.

19. The apparatus of claim 10, wherein the object is a toilet paper holder.

20. The apparatus of claim 19, wherein the single elongate flexible member includes enough length to extend beyond a roll of toilet paper coupled to the toilet paper holder.
